(19) United States
(12) Patent Application Publication
(10) Pub. No.: US 2024/0070455 A1
(43) Pub. Date: Feb. 29, 2024

(54) SYSTEMS AND METHODS FOR NEURAL ARCHITECTURE SEARCH

(71) Applicant: Samsung Electronics Co., Ltd., Suwon-si (KR)

(72) Inventors: Mostafa EL-KHAMY, San Diego, CA (US); Yanlin ZHOU, San Diego, CA (US)

(21) Appl. No.: 18/148,418

(22) Filed: Dec. 29, 2022

Related U.S. Application Data
(60) Provisional application No. 63/400,262, filed on Aug. 23, 2022.
(60) Provisional application No. 63/400,691, filed on Aug. 24, 2022.

(51) Int. Cl. G06N 3/08

(52) U.S. Cl. CPC G06N 3/08

(57) ABSTRACT

A system and a method are disclosed for neural architecture search. In some embodiments, the method includes: processing a training data set with a neural network during a first epoch of training of the neural network; computing a training loss using a smooth maximum unit regularization value; and adjusting a plurality of multiplicative connection weights and a plurality of parametric connection weights of the neural network in a direction that reduces the training loss.

### CROSS-REFERENCE TO RELATED APPLICATION

This application claims the priority benefit under 35 U.S.C. § 119(e) of (i) U.S. Provisional Application No. 63/400,262, filed Aug. 23, 2022, entitled “REGULARIZING AND SPEEDING UP THE DIFFERENTIABLE ARCHITECTURE SEARCH WITH MEAN REGULARIZATION”, and (ii) U.S. Provisional Application No. 63/400,691, filed Aug. 24, 2022, entitled “REGULARIZING AND SPEEDING UP THE DIFFERENTIABLE ARCHITECTURE SEARCH WITH MEAN REGULARIZATION”, the disclosures of both of which are incorporated by reference in their entirety as if fully set forth herein.

### TECHNICAL FIELD

The disclosure generally relates to neural networks. More particularly, the subject matter disclosed herein relates to improvements to neural architecture search.

### SUMMARY

Neural networks may be trained, once an architecture has been selected, by various training methods including, e.g., supervised training using back-propagation. The selecting of an architecture, however, may involve a time-consuming trial-and-error method.

To solve this problem, neural architecture search (NAS) involves automatically designing a deep neural network (DNN) that can achieve acceptable performance while avoiding time-consuming and error-prone human design.

Related art methods for performing neural architecture search (NAS) may use continuous relaxation of candidates and a one-step approximation of bi-level optimization. One issue with such an approach is that some related art methods suffer from performance collapse caused by aggregation of skip connections. Some related art NAS approaches endeavor to resolve the performance collapse problem by redesigning the architecture update process (e.g., using an auxiliary skip connection, or a limited skip connection allowance), or by improving supernet optimization (using e.g., early stopping, constraints, perturbation, or Hessian regularization).

Some related art methods may exhibit a discrepancy between the performance of the over-parameterized supernet and its final derived child network. For example, during a supernet search phase, all operations may be used between feature maps in a weight-sum manner. When deriving the final network, all but one of the operations are pruned between connected feature maps, leaving the operation with the largest contribution in a supernet. The use of L1 or L2 metrics, or of weight-decay loss, may be ineffective for the supernets of such related art methods.

To overcome these issues, systems and methods are described herein for using a loss function that mitigates some or all of the above-described issues. Further, various methods, such as processing only a portion of the channels in each epoch of training, may be employed to improve the rate at which training is performed. The above approaches improve on previous methods because, for example, performance collapse may be mitigated.

According to an embodiment of the present disclosure, there is provided a method, including: processing a training data set with a neural network during a first epoch of training of the neural network; computing a training loss using a smooth maximum unit regularization value; and adjusting a plurality of multiplicative connection weights and a plurality of parametric connection weights of the neural network in a direction that reduces the training loss.

In some embodiments: the computing of the training loss includes evaluating a loss function; the loss function is based on a plurality of inputs including the parametric connection weights; and the loss function has the property that: for a first set of input values, the loss function has a first value, the first set of input values consisting of: a first set of parametric connection weights, and a first set of other weights; for a second set of input values, the loss function has a second value, the second set of input values consisting of: a second set of parametric connection weights, and the first set of other weights; each of the first set of parametric connection weights is less than zero; one of the second set of parametric connection weights is less than a corresponding one of the first set of parametric connection weights; and the second value is less than the first value.

In some embodiments, the loss function includes a first term and a second term, the first term being a cross entropy function of the parametric connection weights.

In some embodiments: the loss function includes a first term and a second term, the second term including a plurality of sub-terms, a first sub-term of the sub-terms being proportional to a first parametric connection weight of the parametric connection weights; and a second sub-term of the sub-terms is proportional to an error function of a term proportional to the first parametric connection weight.

In some embodiments, the method includes: processing the training data set with the neural network during a plurality of epochs of training of the neural network, the plurality of epochs including the first epoch; and adjusting, for each epoch, the multiplicative connection weights and the parametric connection weights of the neural network in a direction that reduces the loss function.

In some embodiments, the adjusting of the multiplicative connection weights and the parametric connection weights causes the loss function to be reduced over each of three consecutive epochs.

In some embodiments, the adjusting of the multiplicative connection weights and the parametric connection weights causes the loss function to be reduced over each of ten consecutive epochs.

In some embodiments, the adjusting of the multiplicative connection weights and the parametric connection weights causes a largest multiplicative connection weight of the multiplicative connection weights to have a value exceeding the value of a second-largest multiplicative connection weight of the multiplicative connection weights by at least 2% of the difference between the largest multiplicative connection weight and a smallest multiplicative connection weight of the multiplicative connection weights.

In some embodiments, the adjusting of the multiplicative connection weights and the parametric connection weights causes the largest multiplicative connection weight to have a value exceeding the value of the second-largest multiplicative connection weight by at least 5% of the difference between the largest multiplicative connection weight and the smallest multiplicative connection weight.

According to an embodiment of the present disclosure, there is provided a system including: one or more processing circuits; a memory storing instructions which, when executed by the one or more processing circuits, cause performance of: processing a training data set with a neural network during a first epoch of training of the neural network; computing a training loss using a smooth maximum unit regularization value; and adjusting a plurality of multiplicative connection weights and a plurality of parametric connection weights of the neural network in a direction that reduces the training loss.

In some embodiments: the computing of the training loss includes evaluating a loss function; the loss function is based on a plurality of inputs including the parametric connection weights; and the loss function has the property that: for a first set of input values, the loss function has a first value, the first set of input values consisting of: a first set of parametric connection weights, and a first set of other weights; for a second set of input values, the loss function has a second value, the second set of input values consisting of: a second set of parametric connection weights, and the first set of other weights; each of the first set of parametric connection weights is less than zero; one of the second set of parametric connection weights is less than a corresponding one of the first set of parametric connection weights; and the second value is less than the first value.

In some embodiments, the loss function includes a first term and a second term, the first term being a cross entropy function of the parametric connection weights.

In some embodiments: the loss function includes a first term and a second term, the second term including a plurality of sub-terms, a first sub-term of the sub-terms being proportional to a first parametric connection weight of the parametric connection weights; and a second sub-term of the sub-terms is proportional to an error function of a term proportional to the first parametric connection weight.

In some embodiments, the instructions cause performance of: processing the training data set with the neural network during a plurality of epochs of training of the neural network, the plurality of epochs including the first epoch; and adjusting, for each epoch, the multiplicative connection weights and the parametric connection weights of the neural network in a direction that reduces the loss function.

In some embodiments, the adjusting of the multiplicative connection weights and the parametric connection weights causes the loss function to be reduced over each of three consecutive epochs.

In some embodiments, the adjusting of the multiplicative connection weights and the parametric connection weights causes the loss function to be reduced over each of ten consecutive epochs.

In some embodiments, the adjusting of the multiplicative connection weights and the parametric connection weights causes a largest multiplicative connection weight of the multiplicative connection weights to have a value exceeding the value of a second-largest multiplicative connection weight of the multiplicative connection weights by at least 2% of the difference between the largest multiplicative connection weight and a smallest multiplicative connection weight of the multiplicative connection weights.

In some embodiments, the adjusting of the multiplicative connection weights and the parametric connection weights causes the largest multiplicative connection weight to have a value exceeding the value of the second-largest multiplicative connection weight by at least 5% of the difference between the largest multiplicative connection weight and the smallest multiplicative connection weight.

According to an embodiment of the present disclosure, there is provided a system including: means for processing; a memory storing instructions which, when executed by the means for processing, cause performance of: processing a training data set with a neural network during a first epoch of training of the neural network; computing a training loss using a smooth maximum unit regularization value; and adjusting a plurality of multiplicative connection weights and a plurality of parametric connection weights of the neural network in a direction that reduces the training loss.

In some embodiments: the computing of the training loss includes evaluating a loss function; the loss function is based on a plurality of inputs including the parametric connection weights; and the loss function has the property that: for a first set of input values, the loss function has a first value, the first set of input values consisting of: a first set of parametric connection weights, and a first set of other weights; for a second set of input values, the loss function has a second value, the second set of input values consisting of: a second set of parametric connection weights, and the first set of other weights; each of the first set of parametric connection weights is less than zero; one of the second set of parametric connection weights is less than a corresponding one of the first set of parametric connection weights; and the second value is less than the first value.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram of a portion of a neural network, according to an embodiment of the present disclosure;

FIG. 2 is a block diagram of a portion of a neural network, according to an embodiment of the present disclosure;

FIG. 3 is a flowchart, according to an embodiment of the present disclosure; and

FIG. 4 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form.

It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, the term “or” should be interpreted as “and/or”, such that, for example, “A or B” means any one of “A” or “B” or “A and B”.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

Related art methods for performing neural architecture search (NAS) may use continuous relaxation of candidates and a one-step approximation of bi-level optimization. However, as mentioned above, some related art methods suffer from performance collapse which may be caused by an aggregation of skip connections. Some related art NAS approaches endeavor to resolve the performance collapse problem by redesigning the architecture update process (e.g., using an auxiliary skip connection, or a limited skip connection allowance), or by improving supernet optimization (using e.g., early stopping, constraints, perturbation, or Hessian regularization).

Related art NAS methods may search for repeatedly stacked cells to construct a convolutional neural network (CNN). Each computation cell k may be a directed acyclic graph (DAG) with seven nodes, with two input nodes from the immediately previous cells k−1 and k−2, four intermediate nodes, and an output node. Each node Xᵢ is a feature map, and each directed edge (i,j) between nodes may contain eight operations to transform Xᵢ to Xⱼ. These operations may include, for example: convolutions (e.g., 1×1 or 3×3 convolutions (or “conv”)), e.g., {3×3, 5×5} separable convolutions or {3×3, 5×5} dilated separable convolutions, 3×3 {max, average} pooling (e.g., average pooling, or “avg pool”), identity (or “skip”, or “skip connect”), and zero (or “none”). In the searching phase, a NAS method may start with a supernet using all eight operations on feature maps. To make the search space continuous, the method may relax the categorical choice of a particular operation to a softmax over all possible operations.

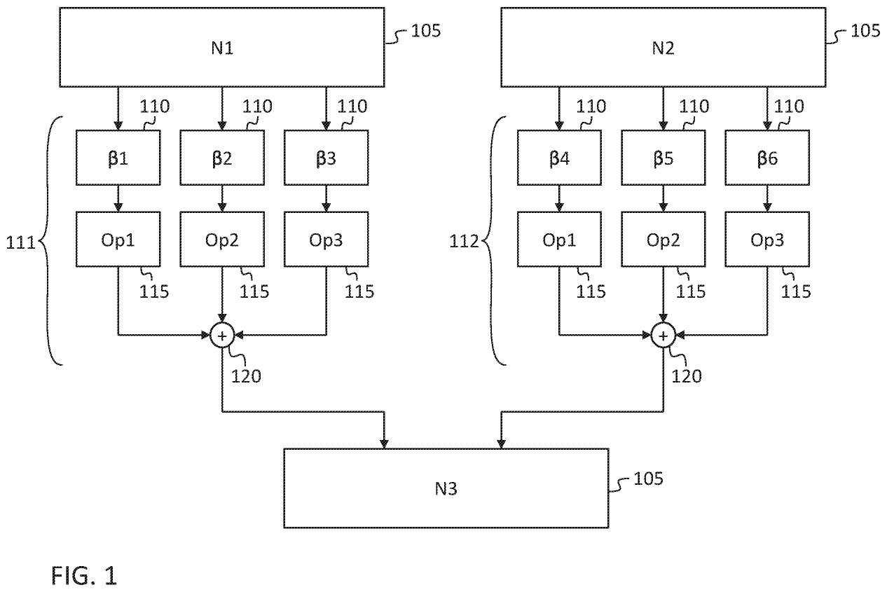

FIG. 1 shows a portion of such a neural network, including three nodes 105, a plurality of multiplicative connection weights 110 (each of which may be referred to as μ), and a plurality of operations 115. Each of a first node N1 and a second node N2 is connected to a third node N3. The first node N1 is connected to the third node N3 by a first edge 111, and the second node N2 is connected to the third node N3 by a second edge 112. The first edge 111 includes a plurality of connections, each connection including a multiplicative connection weight 110 and an operation 115. The connections are summed by an adder 120 (which may be a dedicated circuit or an instruction performed by a processing circuit capable of other operations). There may be two or more operations (e.g., three, as illustrated in FIG. 1, or the 8 operations listed above) in each edge. If, after training, the multiplicative connection weight 110 for a first operation 115 is nonzero on one edge, and the remaining multiplicative connection weights 110 for the edge are all zero, then on that edge, the connection is one that performs the first operation. The method may define parametric connection weights a as indicators for the contribution of each operator 115. The corresponding multiplicative connection weights 110 may then be calculated as:

$${β}_{o}^{i , j} = \frac{exp ( {α}_{o}^{i , j} )}{{\sum }_{{o}^{′} ∈ O} exp ( {α}_{{o}^{′}}^{i , j} )}$$

where i and j are identifiers of the two nodes connected by the edge. As used herein, a “parametric connection weight” is a value that when used in place of the αₒ^{i,j} in the equation above, the result is a multiplicative connection weight βₒ^{i,j}. As such, for example, if

$$β = \frac{exp ( - {θ}_{o}^{i , j} )}{{\sum }_{{o}^{′} ∈ O} exp ( - {θ}_{{o}^{′}}^{i , j} )} ,$$

then the set of −θₒ^{i,j} are parametric connection weights.

The continuous relaxation of discrete operation choices becomes:

$${\overline{o}}^{( i , j )} ( x ) = {\sum }_{o ∈ O} \frac{exp ( {α}_{o}^{i , j} )}{{\sum }_{{o}^{′} ∈ O} exp ( {α}_{{o}^{′}}^{i , j} )} o ( x )$$

where O is the operation set.

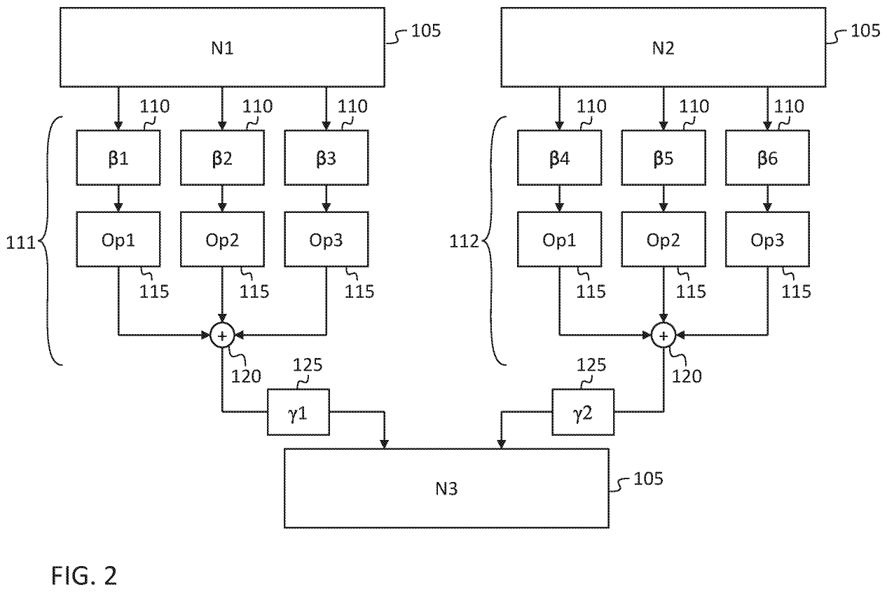

The task of architecture search then reduces to learning a set of continuous a variables (the parametric connection weights), which encode the architecture of the neural network. Supervised training of the neural network, to adjust the parametric connection weights 110 as well as other weights (e.g., internal weights such as the elements of convolution kernels and edge weights 125 (FIG. 2, discussed in further detail below)), may be performed by, e.g., processing a labeled data set with the neural network, evaluating a loss function, and adjusting the weights in a direction that reduces the loss function (e.g., that reduces the value of the loss function). As used herein, a loss function is “reduced” when its value changes in a direction indicating that the performance of the neural network is improving. The supervised training may involve performing training, with a training data set, over a plurality of epochs. For each epoch of training of the neural network, the training may involve processing the training data set with the neural network during the epoch, and adjusting a plurality of multiplicative connection weights and a plurality of parametric connection weights of the neural network in a direction that reduces the loss function. The loss function may be, or include, a cross entropy term of the parametric connection weights.

As mentioned above, some such methods may suffer from performance collapse. In this situation, the skip connection may dominate the search stage and the network may converge to the all skip network. In addition, some methods may suffer from discrepancy of discretization. In this situation, several α values may be very close to each other, which may be an obstacle to eventually choosing the best operation for one or more edges of a cell. In some embodiments, therefore, mean regularization may be performed. For example, mean regularization (MR) may employ a loss function term as follows:

$$L = \frac{λ}{N} {\sum }_{n = 0}^{N} {α}_{n} ,$$

where L is a mean regularization term which may be added to the loss function as an additional regularization term, N is the product of the number of all candidate operations and the number of edges, λ is a coefficient to control the regularization strength, which may be (but need not be) a fixed or adaptive value (e.g., a linearly increasing value), and a is the contributing weight of candidate operations. It may be seen that the right-hand side of this term of the loss function includes N+1 sub-terms, each proportional to a respective parametric connection weight. Each α may be (but need not be) the contributing weight of one of: an operation, an edge, an individual channel, or a number of channels, blocks, layers, or feature size. A loss function term based on mean regularization is a special case of a more general regularization (which may be referred to as smooth maximum unit regularization) which is given by the following equation:

$$L = \frac{λ}{N} {\sum }_{n = 0}^{N} \frac{( 1 + v ) {α}_{n} + ( 1 - v ) {α}_{n} erf ( μ ( 1 - v ) {α}_{n} )}{2} ,$$

where ν and μ are controlling parameters which may be employed, for example, to enable the term to approximate the general maxout family. It may be seen that the right-hand side of this term of the loss function includes 2N+2 sub-terms, half of which are each proportional to a respective parametric connection weight, and the remainder of which are each proportional to an error function of a term proportional to a respective parametric connection weight. The values of the parameters ν and μ may be selected based on the task. For instance, if ν=0.25 and μ=∞, the above equation reduces to the equation for mean regularization. The use of such a loss function may result in a method that is able to avoid performance collapse and discretization discrepancy, with no added computational cost during inference.

Such a loss function may have the characteristic that for sufficiently negative values of the parametric connection weights, the value of the loss function decreases as the parametric connection weights become increasingly negative (i.e., as the absolute values of the negative parametric connection weights increase). As such, the loss function may have the property that (i) for a first set of input values, the loss function has a first value, the first set of input values consisting of a first set of parametric connection weights, and a first set of other weights, (ii) for a second set of input values, the loss function may have a second value, the second set of input values consisting of a second set of parametric connection weights, and the first set of other weights, where each of the first set of parametric connection weights may be less than zero, one of the second set of parametric connection weights may be less than a corresponding one of the first set of parametric connection weights, and the second value may be less than the first value.

Moreover, the search may be sped up by updating only a portion of the channels, or by using channel attention. In an embodiment in which only a portion of the channels is updated, for each of the remaining channels, the input may be transmitted, unchanged, to the output (e.g., to the next node). This may be equivalent to using a skip connection for each of the channels not being updated. Such a method may be referred to as a partial channel (PC) method. To reduce stochastic variation introduced by channel sampling, edge weights 125 may be introduced, as illustrated in FIG. 2.

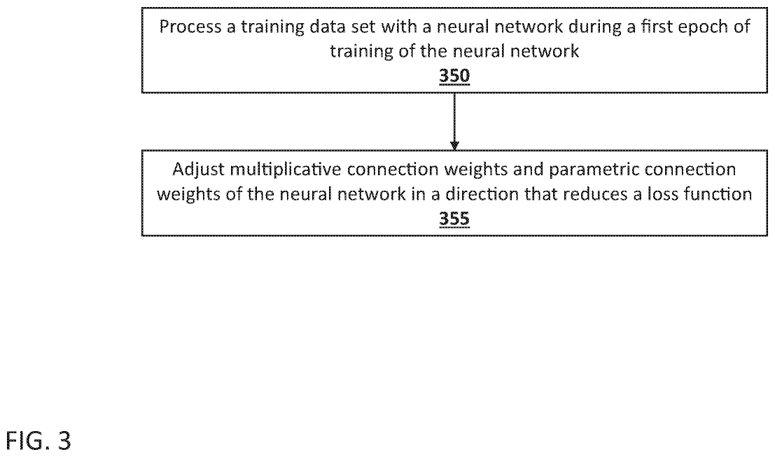

FIG. 3 is a flowchart of a method, in some embodiments. The method may include processing, at 350, a training data set with a neural network during a first epoch of training of the neural network; and adjusting, at 355, multiplicative connection weights and parametric connection weights of the neural network in a direction that reduces a loss function. A neural network that results from the training may have various uses. For example, it may be used to perform classification (e.g., classifying an image based on identifying an object or a person in the image, or classifying a portion of an audio recording based on identifying a spoken word in the audio recording). A system including the neural network may, after a classification is performed, report the result of the classification to a user (e.g., by displaying the result to the user or sending the notification to the user (e.g., via Short Message Service (SMS) or email)).

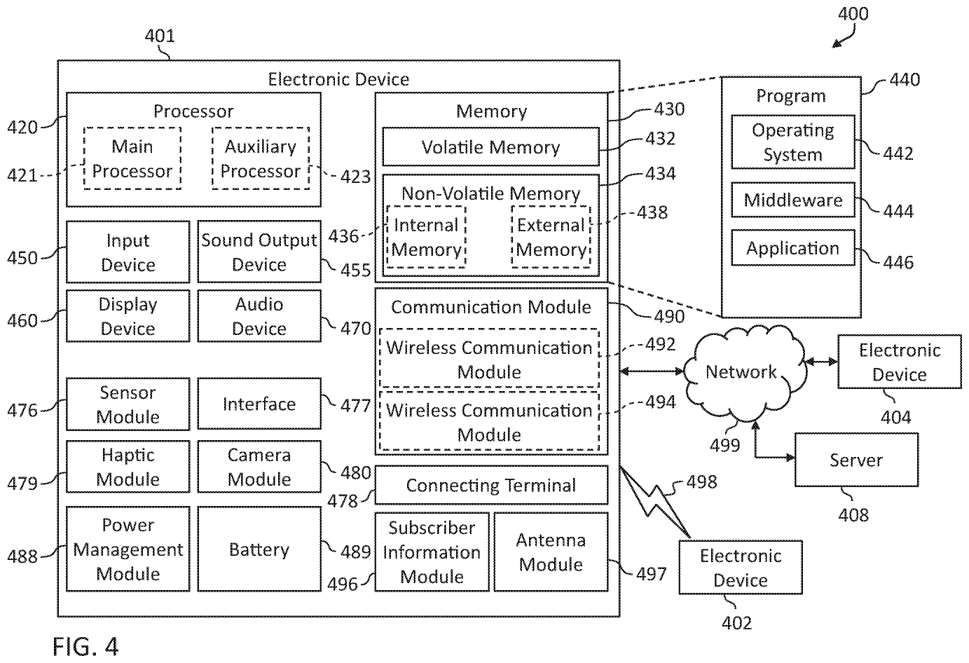

FIG. 4 is a block diagram of an electronic device in a network environment 400, according to an embodiment. Such a device may include a processing circuit suitable for performing, or configured to perform, methods (e.g., methods for training neural networks) disclosed herein. Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 440, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 494. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 446 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as Bluetooth™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
processing a training data set with a neural network during a first epoch of training of the neural network;
computing a training loss using a smooth maximum unit regularization value; and
adjusting a plurality of multiplicative connection weights and a plurality of parametric connection weights of the neural network in a direction that reduces the training loss.

2. The method of claim 1, wherein:
the computing of the training loss comprises evaluating a loss function;
the loss function is based on a plurality of inputs including the parametric connection weights; and
the loss function has the property that:
for a first set of input values, the loss function has a first value, the first set of input values consisting of:
a first set of parametric connection weights, and
a first set of other weights;
for a second set of input values, the loss function has a second value, the second set of input values consisting of:
a second set of parametric connection weights, and
the first set of other weights;
each of the first set of parametric connection weights is less than zero;
one of the second set of parametric connection weights is less than a corresponding one of the first set of parametric connection weights; and
the second value is less than the first value.

3. The method of claim 2, wherein the loss function includes a first term and a second term, the first term being a cross entropy function of the parametric connection weights.

4. The method of claim 2, wherein:
the loss function includes a first term and a second term, the second term comprising a plurality of sub-terms, a first sub-term of the sub-terms being proportional to a first parametric connection weight of the parametric connection weights; and
a second sub-term of the sub-terms is proportional to an error function of a term proportional to the first parametric connection weight.

5. The method of claim 4, comprising:
processing the training data set with the neural network during a plurality of epochs of training of the neural network, the plurality of epochs including the first epoch; and
adjusting, for each epoch, the multiplicative connection weights and the parametric connection weights of the neural network in a direction that reduces the loss function.

6. The method of claim 5, wherein the adjusting of the multiplicative connection weights and the parametric connection weights causes the loss function to be reduced over each of three consecutive epochs.

7. The method of claim 6, wherein the adjusting of the multiplicative connection weights and the parametric connection weights causes the loss function to be reduced over each of ten consecutive epochs.

8. The method of claim 5, wherein the adjusting of the multiplicative connection weights and the parametric connection weights causes a largest multiplicative connection weight of the multiplicative connection weights to have a value exceeding the value of a second-largest multiplicative connection weight of the multiplicative connection weights by at least 2% of the difference between the largest multiplicative connection weight and a smallest multiplicative connection weight of the multiplicative connection weights.

9. The method of claim 8, wherein the adjusting of the multiplicative connection weights and the parametric connection weights causes the largest multiplicative connection weight to have a value exceeding the value of the second-largest multiplicative connection weight by at least 5% of the difference between the largest multiplicative connection weight and the smallest multiplicative connection weight.

10. A system comprising:
one or more processing circuits;
a memory storing instructions which, when executed by the one or more processing circuits, cause performance of:
processing a training data set with a neural network during a first epoch of training of the neural network;
computing a training loss using a smooth maximum unit regularization value; and
adjusting a plurality of multiplicative connection weights and a plurality of parametric connection weights of the neural network in a direction that reduces the training loss.

11. The system of claim 10, wherein:
the computing of the training loss comprises evaluating a loss function;
the loss function is based on a plurality of inputs including the parametric connection weights; and
the loss function has the property that:
for a first set of input values, the loss function has a first value, the first set of input values consisting of:
a first set of parametric connection weights, and
a first set of other weights;
for a second set of input values, the loss function has a second value, the second set of input values consisting of:
a second set of parametric connection weights, and
the first set of other weights;
each of the first set of parametric connection weights is less than zero;
one of the second set of parametric connection weights is less than a corresponding one of the first set of parametric connection weights; and
the second value is less than the first value.

12. The system of claim 11, wherein the loss function includes a first term and a second term, the first term being a cross entropy function of the parametric connection weights.

13. The system of claim 11, wherein:
the loss function includes a first term and a second term, the second term comprising a plurality of sub-terms, a first sub-term of the sub-terms being proportional to a first parametric connection weight of the parametric connection weights; and
a second sub-term of the sub-terms is proportional to an error function of a term proportional to the first parametric connection weight.

14. The system of claim 13, wherein the instructions cause performance of:
processing the training data set with the neural network during a plurality of epochs of training of the neural network, the plurality of epochs including the first epoch; and
adjusting, for each epoch, the multiplicative connection weights and the parametric connection weights of the neural network in a direction that reduces the loss function.

15. The system of claim 14, wherein the adjusting of the multiplicative connection weights and the parametric connection weights causes the loss function to be reduced over each of three consecutive epochs.

16. The system of claim 15, wherein the adjusting of the multiplicative connection weights and the parametric connection weights causes the loss function to be reduced over each of ten consecutive epochs.

17. The system of claim 14, wherein the adjusting of the multiplicative connection weights and the parametric connection weights causes a largest multiplicative connection weight of the multiplicative connection weights to have a value exceeding the value of a second-largest multiplicative connection weight of the multiplicative connection weights by at least 2% of the difference between the largest multiplicative connection weight and a smallest multiplicative connection weight of the multiplicative connection weights.

18. The system of claim 17, wherein the adjusting of the multiplicative connection weights and the parametric connection weights causes the largest multiplicative connection weight to have a value exceeding the value of the second-largest multiplicative connection weight by at least 5% of the difference between the largest multiplicative connection weight and the smallest multiplicative connection weight.

19. A system comprising:
means for processing;
a memory storing instructions which, when executed by the means for processing, cause performance of:
processing a training data set with a neural network during a first epoch of training of the neural network;
computing a training loss using a smooth maximum unit regularization value; and
adjusting a plurality of multiplicative connection weights and a plurality of parametric connection weights of the neural network in a direction that reduces the training loss.

20. The system of claim 19, wherein:
the computing of the training loss comprises evaluating a loss function;
the loss function is based on a plurality of inputs including the parametric connection weights; and
the loss function has the property that:
for a first set of input values, the loss function has a first value, the first set of input values consisting of:
a first set of parametric connection weights, and
a first set of other weights;
for a second set of input values, the loss function has a second value, the second set of input values consisting of:
a second set of parametric connection weights, and
the first set of other weights;
each of the first set of parametric connection weights is less than zero;
one of the second set of parametric connection weights is less than a corresponding one of the first set of parametric connection weights; and
the second value is less than the first value.
